(19) United States
(12) Patent Application Publication
(10) Pub. No.: US 2017/0282811 A1
(43) Pub. Date: Oct. 5, 2017

(54) Contractor Bench and Hauler

(71) Applicant: Kim Alden Horn, Eustis, FL (US)

(72) Inventor: Kim Alden Horn, Eustis, FL (US)

(21) Appl. No.: 15/084,391

(22) Filed: Mar. 29, 2016

(51) Int. Cl. B60R 11/00; B25H 1/04

(52) U.S. Cl. CPC B60R 11/00; B25H 1/04; B60R 2011/004; B60R 2011/0082

(57) ABSTRACT

Work bench rotationally mounted to vehicle receiver trailer hitch on a single split, telescoping and rotating pedestal, allowing height and angle changes, selected by user. Table and pedestal pivot to a folded position, this configuration in conjunction with orientation of hitch tube insertion into receiver, result in hauling platform configuration.

### CROSS-REFERENCE TO RELATED APPLICATIONS

Not Applicable

### FEDERALLY SPONSORED RESEARCH

Not Applicable

### SEQUENCE LISTING OR PROGRAM

Not applicable

### BACKGROUND OF THE INVENTION

### Field of Invention

This invention relates to a work bench for supporting and hauling equipment and performing tasks relevant to the job(s) at hand in transit and on location.

### Prior Art

Contractors traditionally have to set up a bench to provide a work surface to perform their trade. My invention mounts to their vehicle's trailer hitch receiver and is useable in transport position, or rotated and locked in any preferred position within its arc of rotation using a friction bolt. The ability to use the bench in its transport position or quickly rotated to a desired position gives its user time savings, allowing more time to be devoted to producing income. Another benefit is the exterior mounting of the contractor's bench, allowing other use of space taken for hauling conventional benches . The contractor's bench is capable of supporting a variety of saws, grinders, drill presses, jigs, oversize table tops, etc. The Contractors bench may be folded and locked in the hauling deck position , creating a deck allowing transport of additional materials to the job site where upon unloading it may quickly be repositioned to the bench position.

### SUMMARY

In accordance with present invention a hitch mounted contractor's bench comprising of a square trailer hitch receiver tube to which a cylindrical tube is affixed, a table with a cylindrical base of an accommodating inside diameter, is able to receive the hitch cylinder tube and act as an axle, pedestal and mount for the table, additionally folds down to a bumper level hauling deck.

In the drawings individual parts are numbered using whole numbers, figures that are closely related have whole numbers with alphabetic suffixes.

### DRAWINGS

### Figures

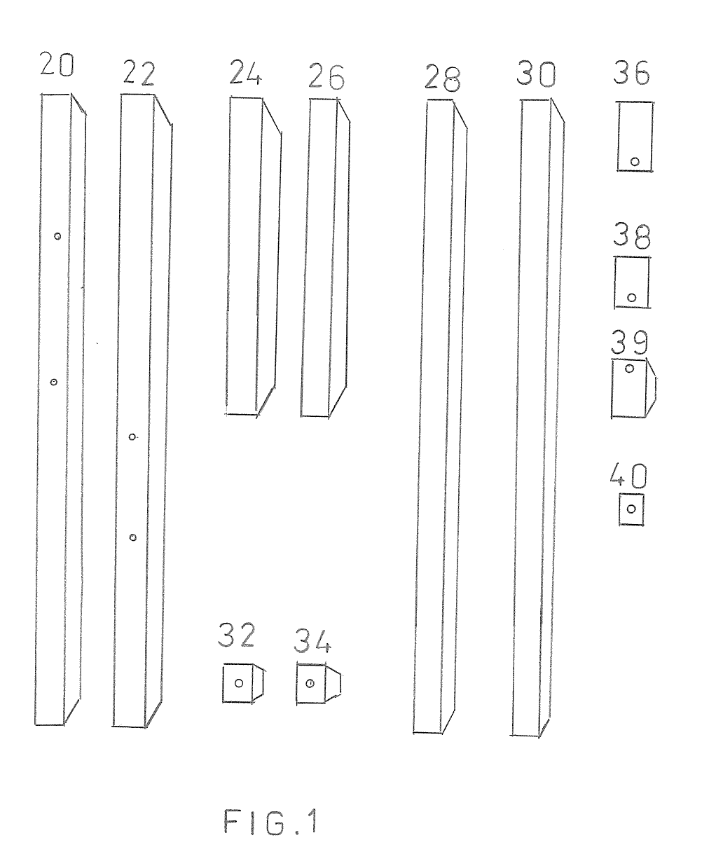

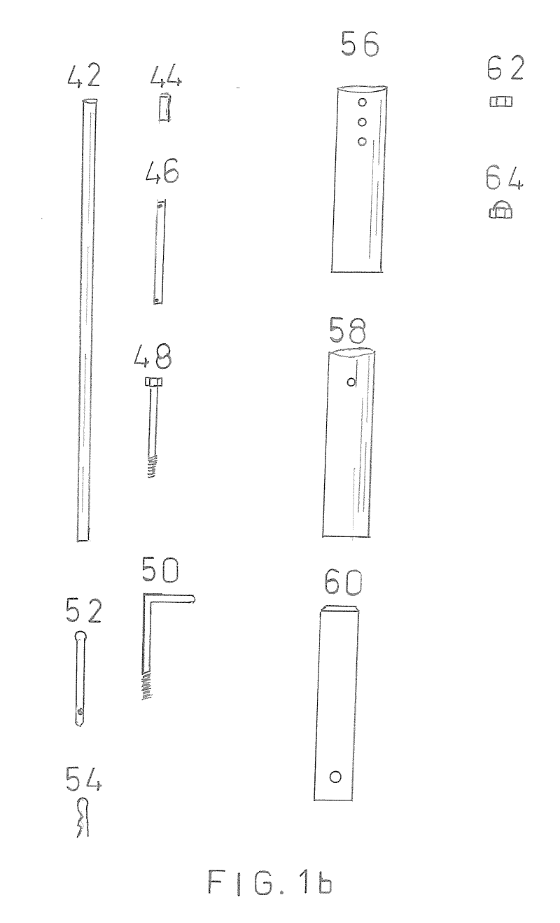

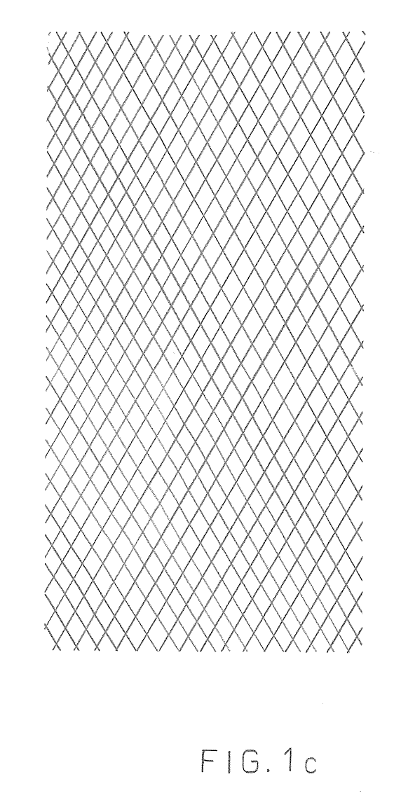

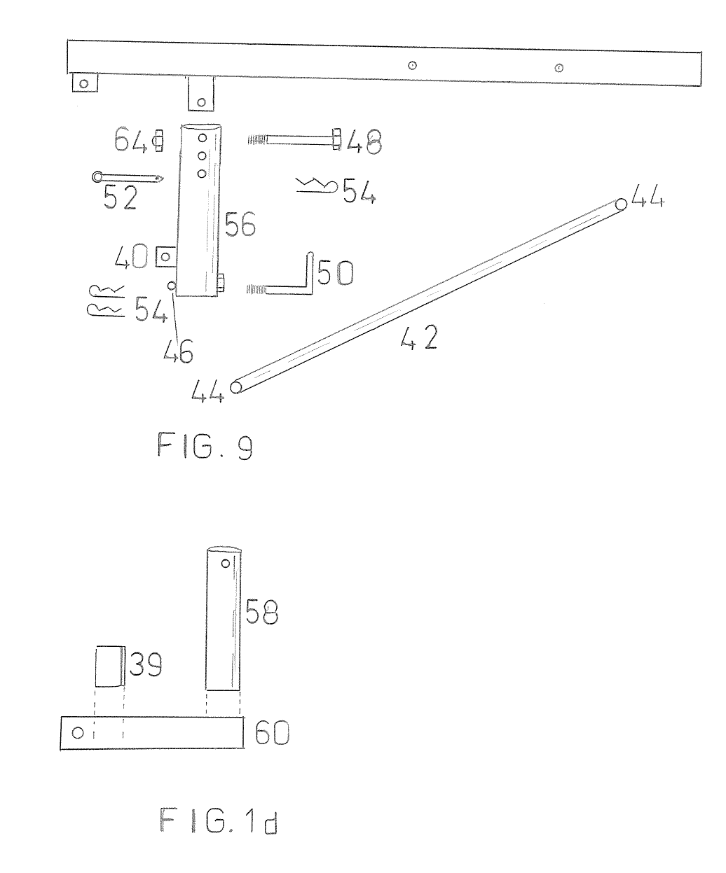

FIG. 1 shows individual frame parts and their assigned numbers

FIG. 1b shows individual pedestal parts and their assigned numbers

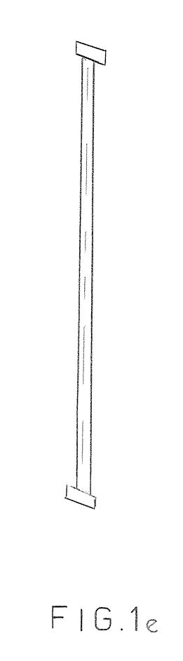

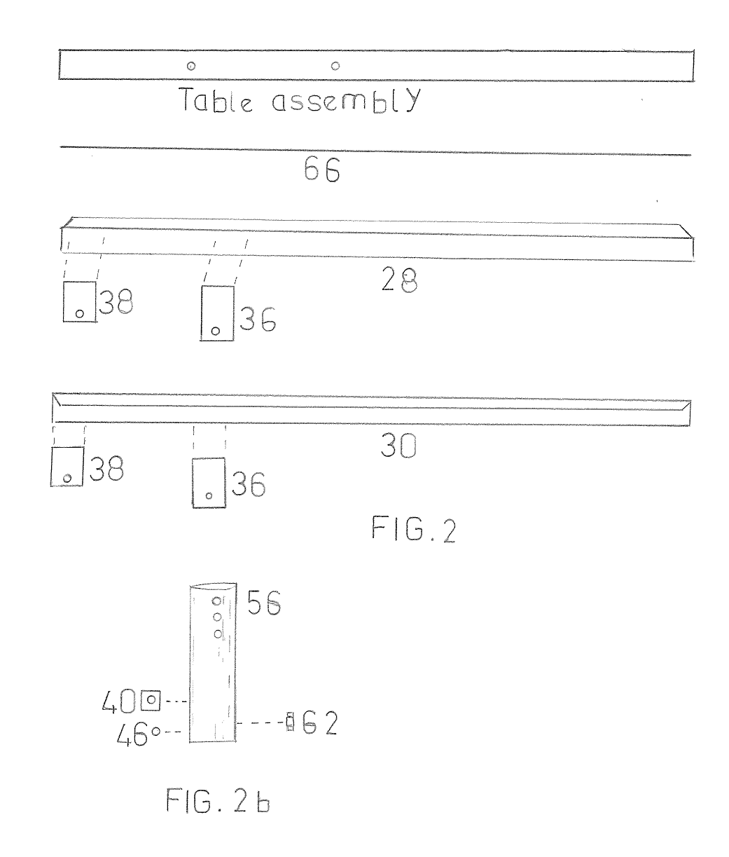

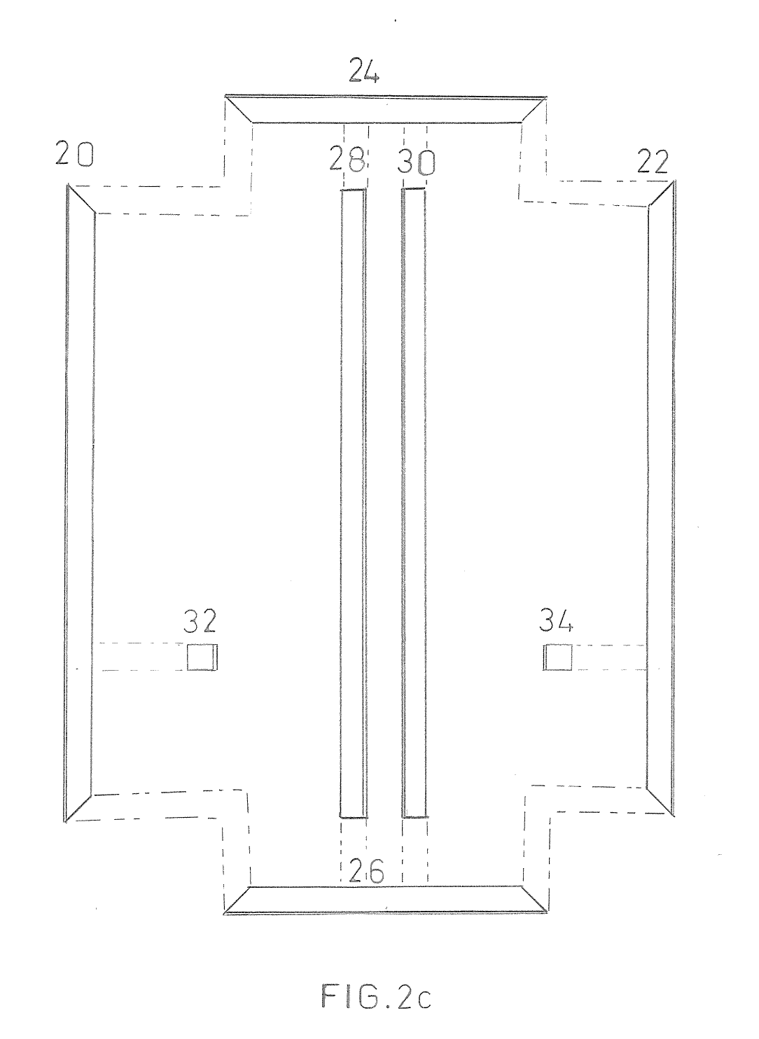

FIG. 2c shows exploded top view of mitered perimeter bench frame members, pedestal support rails and location of support arm brackets, note: expanded steel decking omitted for visual clarity.

FIG. 2 shows assembled outside frame of FIG. 2c, assembly sequence of additional table parts, expanded steel decking, support rails, pedestal mounting brackets and vertical transport brackets.

FIG. 2b shows pedestal outside base tube drilled positions for mounting and elevating, holes for support arm post, vertical lock tab and threaded nut for friction “L” bolt.

FIG. 1c shows expanded steel used as decking material for the bench table surface.

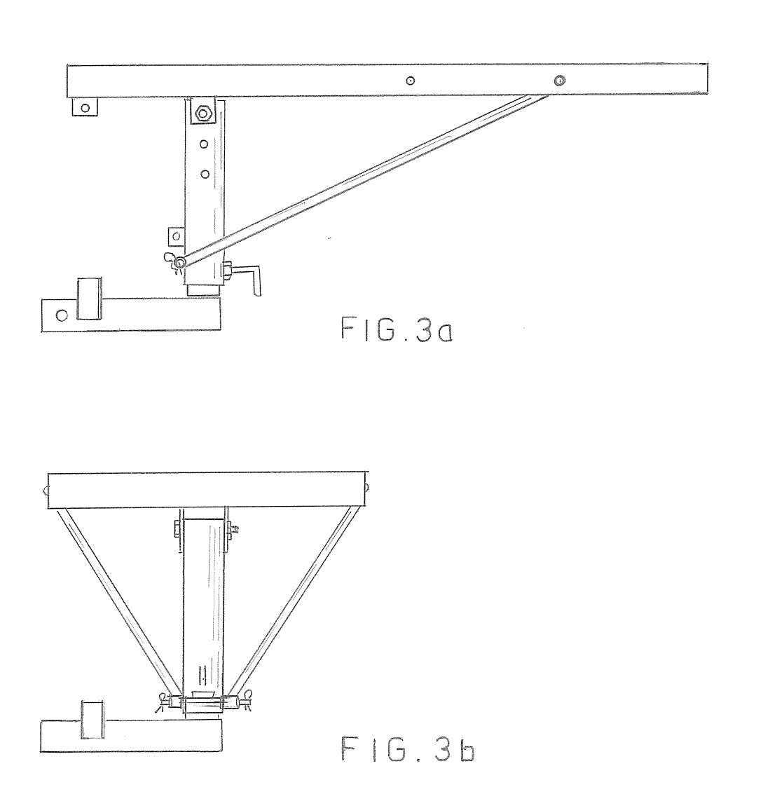

FIG. 3a shows side view of fully assembled bench rotated to extended working position.

FIG. 3b shows side view of fully assembled bench rotated to working and transport.

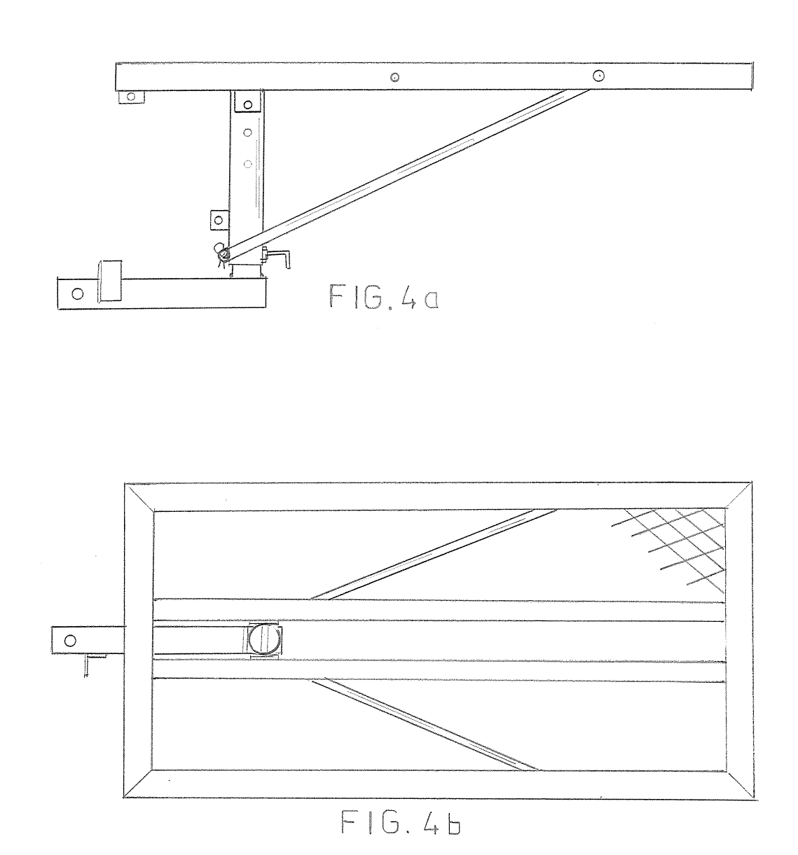

FIG. 4a shows side view of fully assembled bench rotated to extended working position.

FIG. 4b shows top view of fully assembled bench rotated to extended working position note: expanded steel decking cut away for visual clarity.

FIG. 5 shows side view of assembled bench rotated to extended position, support arms removed, table pivoted to upright transport position.

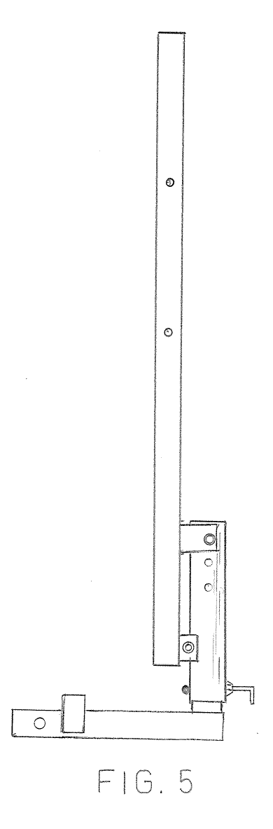

FIG. 6a shows top view of assembled bench folded to its hauling deck position, support arms removed, note: expanded steel decking cut away for visual clarity.

FIG. 6b shows side view of assembled bench folded to its hauling deck position, support arms removed.

FIG. 1d shows trailer hitch receiver tube with placement positions of inner support tube and hauler position bracket.

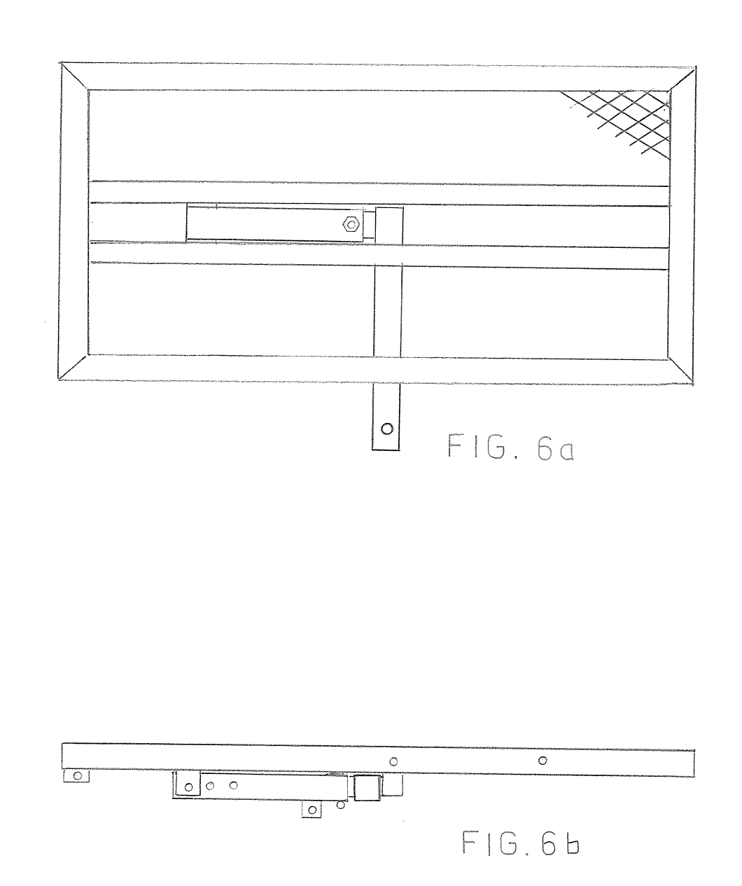

FIG. 9 shows orientation of removable pins, bolts, support arms and retaining clips.

FIG. 1e shows support arm side view

### REFERENCE NUMERALS

20 left angle iron perimeter frame member
22 right angle iron perimeter frame member
24 angle iron perimeter end frame member
26 angle iron perimeter end frame member
28 angle iron support rail for outer cylinder base tube, one of two
30 angle iron support rail for outer cylinder base tube, one of two
32 left support arm frame mounting bracket
34 right support arm frame mounting bracket
56 outer cylindrical pedestal tube
58 inner cylindrical stationary pedestal tube
60 receiver trailer hitch square tube
42 one of two identical support arm tubes
36 one of two identical main pedestal mounting brackets
38 one of two identical upright position lock brackets
50 rotational friction lock threaded “L” bolt
52 one of three identical hitch pins
54 one of five identical hitch pin locking clips
48 bolt for attaching cylindrical post to bench
66 expanded steel deck
62 nut for “L” bolt position lock
64 nylon insert nut for cylinder to bench securing and pivot bolt
46 pedestal mounted support arm attachment post
44 one of four identical tubes used as quick connect pin receivers for support arms
40 vertical position lock tab
39 folded hauling position lock bracket

### DETAILED DESCRIPTION

### FIGS. 3a, 3b, 4b, 5, 6a and 6b

### Preferred Embodiment

A preferred embodiment of the present invention is illustrated in FIG. 3a (side view extended position) FIG. 3b (side view transport position) FIG. 4b (top view extended position) FIG. 5 (side view vertical position) FIG. 6a (top view hauler position) FIG. 6b (side view hauler position) FIG. 1 (part number identification) and FIG. 2 (part number identification)

In FIG. 2c two lengths of 2 inch by 2 inch 3/16 wall angle iron is miter cut at forty five degree angles in 48 inch lengths creating side rails, left part 20 and right part 22. Two additional lengths of same angle iron are cut at forty five degree miters to 24 inch lengths creating frame end rails part 24 and part 26. Frame ends part 24 and part 26 are fitted to the two 48 inch side rails part 20 and part 22 thereby forming a 24 by 48 inch rectangle and welded at miter joints where they meet. Note: the outside angle of the angle iron is the outside edge of frame, when welded into rectangular shape outer flat sides of angle iron present as the sides and top of frame, inside angle of angle iron form the underside of table. To the underside of this 48 inch by 24 inch rectangle a sheet of expanded steel of 3/16 thickness part 66 is cut to 23½ inches by 47 ½ inches leaving ⅛ inch of tolerance to fit for welding to the frames underside inside measurement of 23⅝ by 47⅝ as shown in FIG. 2. Two support angle irons of 1½ inch by 1 1/2 inch angle iron with a wall thickness of 3/16 inch and cut to a length of 47⅝ inches each, produce part 28 left and part 30 right. The support rails are welded to the underside where they contact the end rail 24 at a right angle and opposite end rail 26 at a right angle as shown in FIG. 2. The outside flat of the support rails parts 28 and 30 are in contact with the expanded steel as shown in FIG. 2, the other flat side of the angle iron supports is perpendicular to the expanded steel deck and facing each other. These supports 28 and 30 are parallel to each other and welded to end rails where they meet 1½ inches from center line of the interior width of rectangular frame. The space between center support rails 28 and 30 is 3 inches. Measuring from end rail 24 and perpendicular point of contact to left support rail 28 along length of support rail measuring ¼ inch, locking bracket 38 is welded. Bracket 38 is steel flat stock 2 inch width by ¼ inch thick cut to a length of 2¼ inches, drilled ⅜ inch from end of length and center of width with a ½ inch hole, bracket 38, one of two, is welded to the perpendicular surface of support rail to the interior facing side with ½ inch hole exposed below frame, as shown in all side views. note: the distance between brackets after welding is 2½ inches. Support rail 30 position mirrors support rail 28 where perpendicular flat sides of angle iron face the center of frames length and opposing flat of other angle support rail, and identical second bracket part 38 placement is welded to support rail 30 in a position that mirrors bracket 38 position on rail 28. The two identical pedestal support brackets part 36 are produced of the same steel flat stock as the locking bracket part 38, the pedestal support brackets part 36 are cut to a length of 4 inches drilled with a ½ inch hole ⅜ inch from end and center of width. Brackets are welded to the perpendicular vertical flat of the interior facing sides of support rails is same manner as brackets parts 38, measuring along length of parts 28 and 30 starting where they contact end rail part 24 toward center of frame to a length of 9 inches one bracket is welded to rail 28 and the other bracket is welded to rail 30 with bracket holes exposed below the frame as shown in all side views. Note: the exposed face each bracket part 36 again are mirroring each other and space between brackets is 2½ inches to allow pedestal base tube to be mounted between.

Support arm frame bracket part 32 is welded to underside of perimeter frame rail part 20 at a point 37 inches as measured from frame rails contact point to end rail part 24. Part 32 produced from same angle iron stock as that of support rails 28 and 30, the angle iron is cut to a length of 1½ inches and drilled in the center of one of its flat sides with a ½ inch diameter hole and orientated where the unaltered flat side is welded parallel fully contacting the expanded steel decking, and the perpendicular side with ½ inch hole is orientated parallel to the outside edge of frame part 20 and aligned with corresponding hole, with a space between the parallel flats measuring 1½ inches. The right support arm bracket part 34 is a mirror placement on side rail 22 to the placement of the left bracket. Note: the brackets and side rails form a square edged “U” shape where the ½ inch holes of each are aligned and a spacing of 1½ inches between the uprights of the “U”, where the center of the “U” receives the end of support arm and a pin can be inserted through all.

The pedestal outside support tube part 56 as shown in FIG. 2b, consisting of 16 inches of schedule 80 steel pipe with a diameter of 2 inches. This pipe is drilled with three ½ inch holes along its length across center of circumference through both walls of pipe, starting at the top edge of pipe and measuring 1 inch from top edge of pipe it is the first hole, used for pivotal mounting to table using parts 36 located on table frame where bolt part 48 is inserted and retained with nut part 64, in same longitudinal line as the mounting bracket hole a height adjustment/rotational lock hole is drilled at 3 inches from top edge and another height adjustment hole is drilled at 5 inches from top edge along same longitudinal line. Measuring 15 inches from top edge of pipe and 90 degrees of rotation from longitudinal line of previous holes, a ½ inch hole is drilled through tube wall where nut part 62 is welded, with center of nut aligned with ½ inch hole. Opposite of the nut, the center of 5 inch long support arm post part 46 is welded to cylinder pedestal base perpendicular to pedestals length, 15 inches from top edge of tube. Directly above support arm post part 46 the vertical position lock tab is welded to base pedestal in the vertical position 12 inches from the top of base pedestal tube as shown in FIG. 9. Vertical lock tab is cut from 1½ inch flat stock ¼ inch thick cut 1½ length where a ½ inch hole is drilled through is 1½ square center as shown in FIG. 2b.

Support arms part 42 are cut from schedule 40 pipe of ½ diameter at length of 36 inches, to each end of pipe part 42 a 1½ length of schedule 40 pipe of ½ diameter part 44 where the pipes length is welded 20 degrees off perpendicular where both parts 44 are parallel in relation to each other welded to the ends of a 36 inch pipe part 42 as shown in FIG. 1e.

Trailer hitch mount is an industry standard two inch square steel receiver tube with a wall thickness of ¼ inch and cut to a length of 16 inches and drilled 2 inches from its end with ⅝ inch holes in the center axis of both flat side walls part 60. Note: holes allow hitch retaining pin to be inserted through receiver tube at any available rotation of its square shape. A schedule 80 cylindrical pipe 16 inches in length and 1½ inch inside diameter part 58 is welded perpendicularly the opposite of drilled end of part 60, as shown in FIG. 1d. Bracket 39 consisting of a 4 inch length of 2 inch by ¼ inch wall angle iron with a ½ inch hole drilled through then center one flat side of angle iron ½ inch from end. The unaltered flat of the angle iron bracket is welded to receiver tube with the length of angle vertically mounted on the same plane as cylindrical tube, with bracket hole extending above receiver tube, this position aligns with table frame lock hole when frame is rotated and folded for hauling configuration as shown in FIG. 1d .

The preferred embodiment utilizes expanded steel decking, some of its benefits are, ease of mounting equipment, placement options throughout the decks entire surface, backing such as fender washers with bolts and nuts placed through the expanded steel open areas give strong and quick retention without need to drill holes. Equipment, jigs, templates and such may use a variety of quick release “L”s, hooks “T” bolts, lock levers, hold downs and many other quick mounting options. Solid decking of any number of materials may also be attached to the expanded steel. Sizes larger, equal or smaller than the deck may also be readily attached. The frame is constructed from 2 inch steel angle iron 3/16 inch wall and the support rails of 1½ inch steel angle iron 3/16 inch wall. The tube in a tube telescopic and rotational pedestal base is constructed of 1½ inch inside diameter schedule 80 steel pipe 16 inches in length, inside a 16 inches in length section of 2 inside diameter inch schedule 80 steel pipe. ½ inch diameter steel schedule 40 steel pipe is used for table supports connected with ½ inch removable pins.

### OPERATION

### FIGS. 3a, 3b, 5, 6a, 6b

The bench consists of three main assemblies. First being the table, deck and bracket assembly as shown in exploded view FIG. 2, brackets 36 serve to attach base sub assembly to the table using bolt 48, this sub assembly consists of the main support tube 56 with support arm pin 46, tab 40 and nut 62 welded over predrilled hole and position holes and mounting hole drilled as shown in FIG. 2b. Bolt 48 secured with nut 64 pivotally attaches table and outside base tube and completes the table and base assembly, this assembly may remain intact while performing all operations of the preferred embodiment of the invention. Second of the three assemblies consist of parts 44 (four identical pieces) one welded 20 degrees off the perpendicular to the ends of (two identical pieces) part 42, collectively creating two support arms with quick release capabilities, when installed in the bench using hitch pins lend stability to the bench configuration, when the bench is under load (use). Third assembly is the hitch receiver 60 with hauler position lock down bracket 39 and inner support cylindrical tube base tube attached. With the hitch receiver tube inserted into a vehicles hitch receiver cylindrical base tube in vertical orientation and secured with hitch pin, the first assembly (with subassembly attached) base tube is slid down over the hitch inner base tube (friction bolt 50 must be in retracted position) until it contacts bolt 48. Placing the table perpendicular to its support base and installing support arms 42 with retaining clips 54, the bench is now in work bench position, free to rotate until friction bolt 50 is tightened.

The Hauler configuration of the preferred embodiment as shown in FIGS. 6a and 6b is achieved by loosening friction bolt 50, rotating bench to transport position as shown in FIG. 3b, tightening friction bolt 50, removing entire unit from vehicle receiver hitch turning unit 90 degrees counter clockwise and reinserting into vehicle receiver hitch, with the arm supports removed the table may then be lowered clockwise to the hauling deck position and secured with pin 52 passed through hitch tube bracket 39 and hole in frame member 20. Straps or ropes may be tied or hooked to the expanded steel deck for easily securing it for transport. Returning to work bench position is the reverse of above instructions.

The upright transport position as shown in FIG. 5 is achieved by placing the unit in work bench position, then rotating to extended position FIG. 3a removing support arms 42 elevating the end of bench furthest from pivot point to the vertical position and inserting pin 52 through table brackets and support post tab 40 to secure to the upright of this configuration. The position shown in FIG. 5 allows the bench to be rotated 360 degrees on its base tube and retained in any degree of its rotation by tightening of friction bolt 50, giving a wide range of clearance when vehicle is hauling over size equipment and or materials in addition to the bench. This ability to rotate also can be used to minimize wind resistance for fuel economy. This minimum wind resistance is also enjoyed when bench is in the work bench transport position as shown in FIG. 3b, additionally this position is usable for production.

### Alternative Embodiments

There are various materials that may be used to construct the contractors bench, steel is the preferred embodiment when strength and costs considerations are foremost. Aluminum construction is of consideration for corrosion resistance and weight reduction, at the expense of production and material cost. Further, using composite materials raise costs above metals, but gains are further weight reduction and elimination of corrosion. There is argument for using a combination of materials, where benefits exceed selected materials costs.

Alternative materials dictate types of surface protective coatings such as paints, powder coatings, epoxies, laminations are but a few to be considered, all may be tinted for color variations. Surface conversion treatments may also applied.

The dimensions of the table may be altered for size specific requirements, the preferred embodiment allows for easy attachment of table decking consisting of other materials and sizes, additionally the size and material of table deck, frame and supports may be exchanged for specific use requirements.

Extending or shortening of the main support tubes 56 and 58 will allow a wider range of user specific height requirements. Support arms 42 may be lengthened or shortened to provide an angled surface if required. The support arms may also be replaced with threaded rods and internally threaded pipe, creating adjustable length arms allowing tilting of the table with-in the range of adjustment.

For increased stability use of an industry standard bolt-on trailer jack may be attached to the square hitch receiver tube and employed to add stabilization to the bench by limiting movement of vehicle's suspension system. Larger decks may be further supported with the addition of fold- out extendable legs that contact the ground surface under the tables foot print.

### ADVANTAGES

From the description above, a number of advantages of the contractor's bench become evident:

(a) The time savings for user is foremost, the transport position allows table to be used as soon as the transport vehicle is stopped. Position changes require a few seconds by loosening of a single hand operated bolt with one hand and swinging table to desired rotation with the other hand an securing the new position by tightening the hand bolt.

(b) The space require to transport the bench is zero, the transport and use are accomplished by mounting the unit in the vehicles trailer hitch receiver, not in the utility space of said vehicle.

(c) Physical effort is minimal as compared to unloading a work bench and support legs from a vehicle, and locating a level surface upon where to set it up.

(d) Equipment, jigs, stationary supports, material support rollers, templates, material clamps, quick release mounts are a few of the items that may be permanently or temporarily mounted to the deck.

(e) The ability of the table section to readily tilt to a vertical transport position gives additional clearance and an extended tie down point for transporting oversized job site materials.

(f) The ability to fold the bench into a hauling platform provides a deck on which additional materials may be transported, or for transporting materials where vapors or dust may not be desirable in an enclosed space with people.

(g) The expanded steel deck provides numerous tie-down locations for hooks, cleats, rope, elastic cords or bolting down of equipment and or materials when used as hauling deck.

Accordingly the reader will see that the contractor's bench and hauler can be quickly and conveniently transported and deployed for use with little or no effort. It can haul materials with a quick configuration change. Its simple design and ease of use allow a wide and varied use for numerous tasks.
It allows equipment to be mounted in multiple locations;
It allows equipment to be mounted back to back for left or right operations where operator may use from single location by swinging table;
It frees up internal vehicle space by mounting outside of vehicle;
It creates additional space to haul equipment and materials;
It saves set-up time required by conventional work surfaces;
It has a adaptable deck for a wide range of uses;
It saves time and labor that multiplies as the number of job sites increase;

Although the description above contains many specificities, these should not be construed as limiting the scope of the invention but as merely providing illustrations of some of the preferred embodiments of this invention. For example the shape of the table deck oval, round, triangular, etc., the post length, the post angle, the hitch receiver tube length, the direction the table folds down, etc.

Thus the scope of the invention should be determined by the appended claims and their legal equivalents, rather than by the examples given.

I claim:

1. A work bench mountable to a vehicles trailer hitch receiver.

2. The bench of claim 1 wherein the pedestal of said bench is comprised of two tubes of predetermined dimensions, the tube of lesser diameter sliding inside the tube of greater diameter, whereby the tube of lesser diameter is the stationary axis of rotation and elevation for the tube of greater diameter.

3. The pedestal of claim 2 wherein the tube of greater diameter is pivotally mounted to the work bench table section of claim 1, whereby the mounting bracket allows said table to pivot until contacting brackets at predetermined locations on the pedestal and hitch receiver tubes, whereby retaining pins may be employed to secure position of the table of claim 1 in selected functional positions.

4. The pedestal tube of lesser diameter of claim 2 wherein said tube is perpendicularly affixed at a predetermined location to hitch receiver tube thereby mountable to a vehicles hitch receiver.

5. The pedestal of claim 2 wherein said tubes form a tube in a tube axle whereby the table and pivotally mounted outside pedestal tube will rotate around stationary inside pedestal tube of claim 4.

6. The bench of claim 1 wherein said utilizes support arms operating in conjunction with brackets located at predetermined locations on pedestal tube and table frame lock pivotal action in bench configuration.

7. The bench of claim 1 wherein removing support arms of claim 6, pivoting said table to an upright position, securing with pins, configures bench to vertical position for transporting.

8. The bench of claim 1 wherein removing support arms of claim 6 allow table section to rotate, pivot and lock whereby bench configures to hitch mounted hauler.

9. The table of claim 1 wherein the expanded steel deck is sandwiched between the underside of the steel frame and the pedestal support members.

10. The pedestal of claim 2 wherein outside cylinder is drilled to receive pins at predetermined positions thereby limiting the depth the inside cylinder may slide, whereby table height is altered.

11. The pedestal of claim 2 wherein outside cylinder is fitted with threaded nut and “L” bolt whereby tightening of said bolt imparts friction against the wall of inside pedestal tube restricting rotation.

12. The pedestal of claim 2 wherein the pivotal mounting allows pedestal to fold against bottom of deck whereby the length of pedestal lies contiguous to the bottom of table frame.
